(19) United States
(12) Patent Application Publication
(10) Pub. No.: US 2019/0173299 A1
(43) Pub. Date: Jun. 6, 2019

(54) MOBILE CHARGING DEVICE CAPABLE OF BATTERY REPLACEMENT

(71) Applicant: COSMEX CO., LTD., New Taipei City (TW)

(72) Inventors: Wan Chieh HSIEH, New Taipei City (TW); Hao-Hong CIOU, New Taipei City (TW); Lin-Yu SIA, New Taipei City (TW); Chun Ching LIU, New Taipei City (TW)

(21) Appl. No.: 16/104,745

(22) Filed: Aug. 17, 2018

(30) Foreign Application Priority Data
Dec. 1, 2017 (TW) 106217937

(51) Int. Cl. H02J 7/00; H01M 10/46

(52) U.S. Cl. CPC H02J 7/0042; H02J 7/0068; H02J 7/0052; H02J 7/0047; H01M 2220/30; H01M 10/46; H02J 2007/0062; H02J 2007/0039; H02J 7/0029

(57) ABSTRACT

The present invention provides a mobile charging device capable of battery replacement, comprising a demountable casing, a control module, and a replaceable battery pack. The demountable casing is demounted or mounted by a demountable means. The control module is disposed in the demountable casing. The replaceable battery pack is disposed in the demountable casing, electrically connected to the control module, controlled by the control module to perform charging or discharging, and is changeable when the demountable casing is demounted. The mobile charging device of the present invention can be directly replaced the battery when the mobile power source is exhausted or insufficient, which enhances practicability.

### BACKGROUND OF THE INVENTION

### 1. Technical Field

The present invention relates to charging devices and, more particularly, to a mobile charging device applicable to fields of nail industry and capable of built-in battery replacement.

### 2. Description of Related Art

Due to technological advancement, various electronic products are becoming more popular. Various consumer electronics, such as smart phones, tablets, and digital cameras, are accessible or usable to people in daily life, indicating that people's daily life is increasingly interwoven with electronic technological products.

With electronic products being ever-changing, their functions are ever-expanding; hence, users nowadays spend more and more time using electronic products. However, built-in power supply devices of electronic products can hardly supply enough power required for long use of the electronic products by users, and in consequence electronic product usage has to halt whenever the electronic products run out of power. Furthermore, heavily powered electronic products, such as nail polishing devices and gel nail radiators, must be directly connected to external power equipment in order to work. As a result, the heavily powered electronic products not only have a limited number of usable places, but are also unportable and inconvenient.

### BRIEF SUMMARY OF THE INVENTION

Batteries, a sort of conventional mobile power source, are usually fixed in place inside electronic products and thus cannot be changed or demounted. Therefore, if a mobile power source is exhausted or insufficient, it must be charged by an external power equipment. If the charging process is not performed timely, the mobile power source will lose its function to the detriment of electronic product usage.

Considering the aforesaid usage-related drawback of the conventional mobile power source, the inventor of the present invention believes that it is necessary to devise a mobile power source capable of battery replacement in order to enhance practicability and convenience of the mobile power source.

The objective of the present invention is to overcome a drawback of the conventional techniques, that is, a mobile power source cannot be charged timely, and thus the mobile power source will lose its function.

To overcome the aforesaid problem, the present invention provides a mobile charging device capable of battery replacement, comprising a demountable casing, a control module, and a replaceable battery pack. The demountable casing is demounted or mounted by a demountable means. The control module is disposed in the demountable casing. The replaceable battery pack is disposed in the demountable casing, electrically connected to the control module, controlled by the control module to perform charging or discharging, and is changeable when the demountable casing is demounted.

Furthermore, the demountable casing comprises a bottom cover and a top cover for covering the bottom cover by the demountable means; and, the demountable means includes a latch structure, engagement structure, magnetic attraction structure, spring structure, leaf spring structure, pivotal rotation structure, or screwing structure.

Furthermore, at least one pushing structure is disposed on the outer side of the top cover.

Furthermore, the pushing structure is convex structure, concave structure, or coarse surface capable of generating friction.

Furthermore, the demountable casing further comprises a limiting device disposed between the bottom cover and the top cover.

Furthermore, the control module comprises a circuit controlling board, a first electrical connection port electrically connected to the circuit controlling board, and at least one socket electrically connected to the circuit controlling board; and, the control module is electrically connected to the changeable battery pack through the first electrical connection port.

Furthermore, the socket is a USB socket and/or a DC socket.

Furthermore, the changeable battery pack comprises a battery casing or a shrink film, at least one electric power storage component disposed in the battery casing or the shrink film, and a second electrical connection port electrically connected to the electric power storage component; and, the changeable battery pack is electrically connected to the control module through the second electrical connection port.

Furthermore, the changeable battery pack further comprises a cell protecting board and a circuit board electrically connected to the electric power storage component and the second electrical connection port; and, the cell protecting board is independent of the circuit board or integrally formed with the circuit board.

Furthermore, at least one first positioning portion is disposed on one side or two sides of the changeable battery pack; and, a second positioning portion is disposed on one side or two sides of inner side of the demountable casing, corresponds in position to and is coupled to the first positioning portion.

Furthermore, the control module further comprises a control interface.

Furthermore, the control module further comprises a display unit for displaying a remaining power level of the changeable battery pack.

Furthermore, the display unit is at least one indicating lamp or a display screen.

Furthermore, the mobile charging device applicable to fields of nail industry.

As above, the present invention has the following advantages comparing with the conventional techniques:

The mobile charging device of the present invention has a demountable casing. The demountable casing has therein demountable and changeable batteries. If the mobile charging device runs out of power or the batteries lose their electric power storage capability, the batteries will be changed, so as to ensure their charging function and enhance practicability and convenience of the mobile charging device.

### BRIEF DESCRIPTION OF THE DRAWINGS

FIG. 1 is a perspective schematic view of a mobile charging device of the present disclosure invention.

FIG. 2 is an exploded schematic view (I) of the mobile charging device of the present invention.

FIG. 3 is an exploded schematic view (II) of the mobile charging device of the present invention.

FIG. 4 is an exploded schematic view (III) of the mobile charging device of the present invention.

FIG. 5 is an exploded schematic view (IV) of the mobile charging device of the present invention.

FIG. 6 is a perspective view of the changeable battery pack of the present invention.

### DETAILED DESCRIPTION OF THE EMBODIMENT OF THE INVENTION

The details and technical solution of the present invention are hereunder described with reference to accompanying drawings. For illustrative sake, the accompanying drawings are not drawn to scale. The accompanying drawings and the scale thereof are restrictive of the present invention.

Throughout the whole document of the present invention, the term “comprises or includes” and/or “comprising or including” used in the document means that one or more other components, steps, operations, and/or the existence or addition of elements are not excluded in addition to the described components, steps, operations and/or elements. The terms “a” and “an” refer to one or to more than one (i.e., to at least one) of the grammatical object of the article.

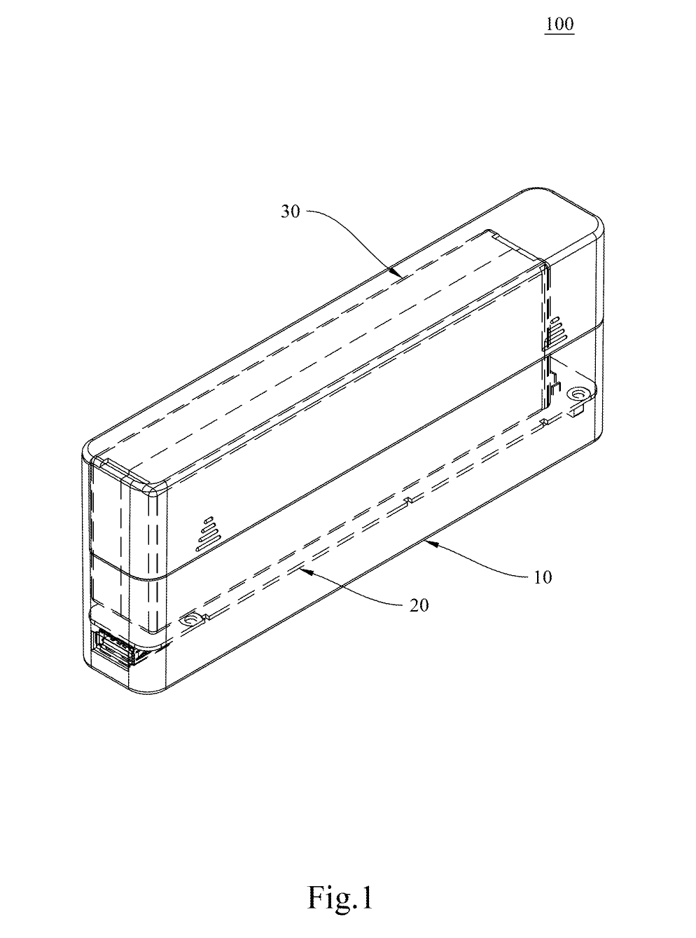

The technical features of the present invention are hereunder illustrated by a preferred embodiment aspect. Referring to FIG. 1, there is shown a perspective schematic view of a mobile charging device of the present invention.

The present invention provides a mobile charging device 100 capable of battery replacement and applicable to various electronic products, especially the fields of nail industry. If the electronic products run out of power, the mobile charging device 100 will be connected to the electronic products to charge the electronic products, so as to extend the service life of the electronic products. The mobile charging device 100 comprises a demountable casing 10, a control module 20, and a changeable battery pack 30. The changeable battery pack 30 can be changed, so as to enhance practicability and convenience of the mobile charging device 100.

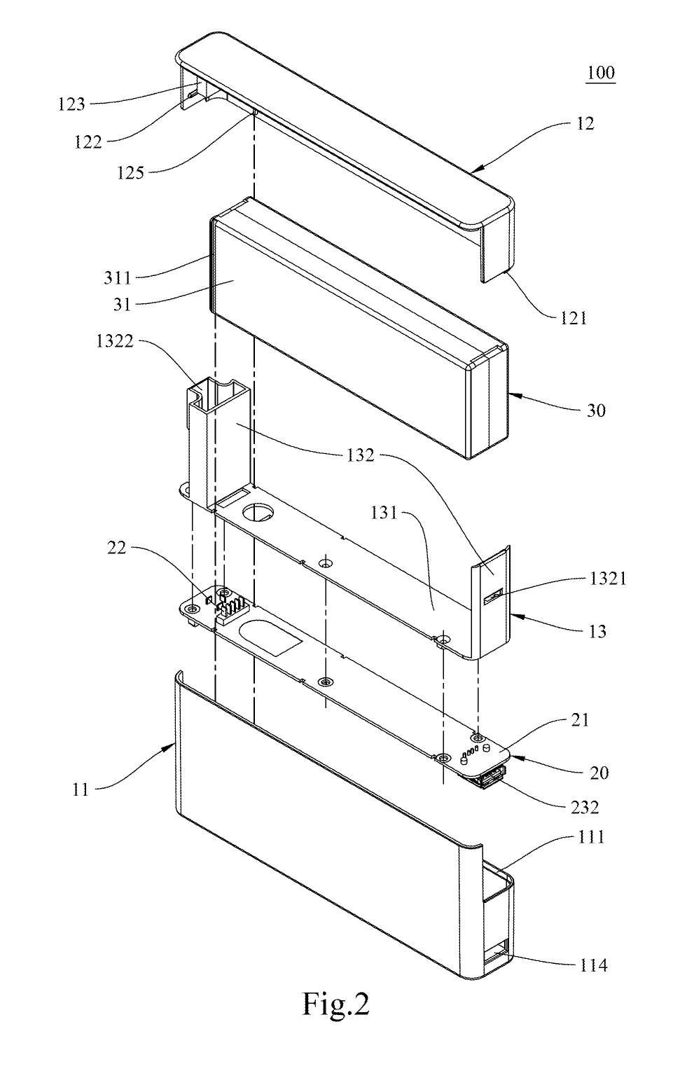

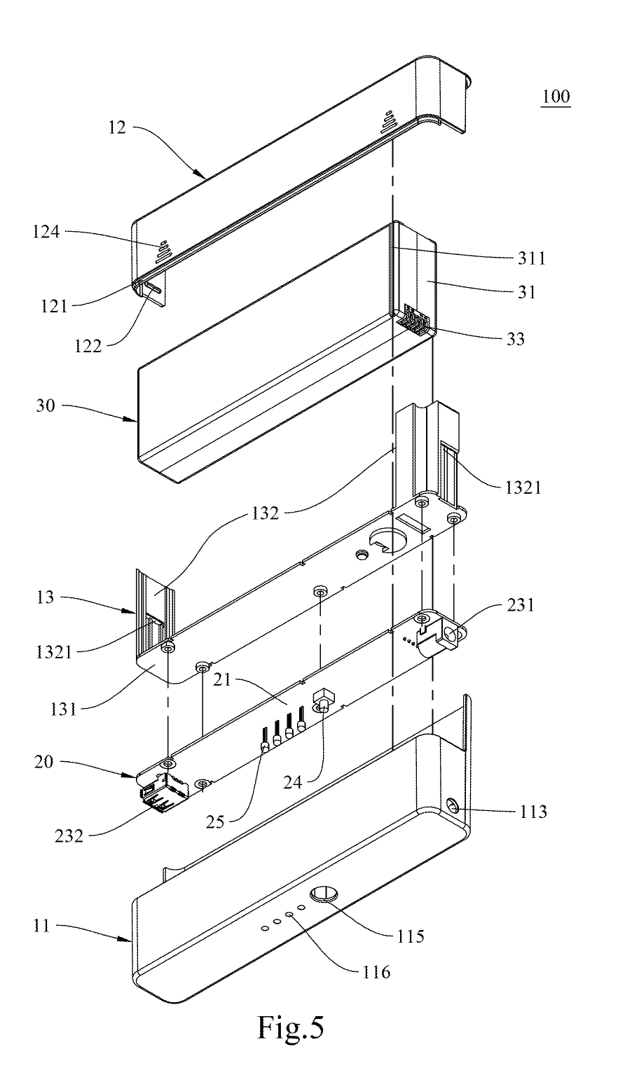

Referring to FIG. 2 through FIG. 5, there are shown exploded schematic views of the mobile charging device taken from different angles according to the present invention.

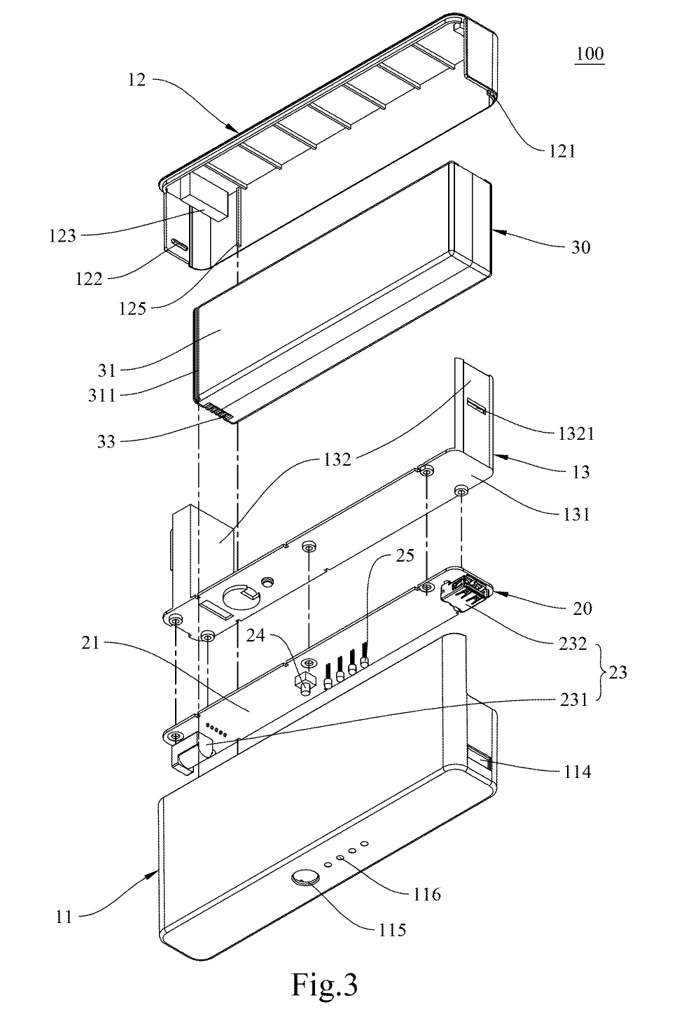

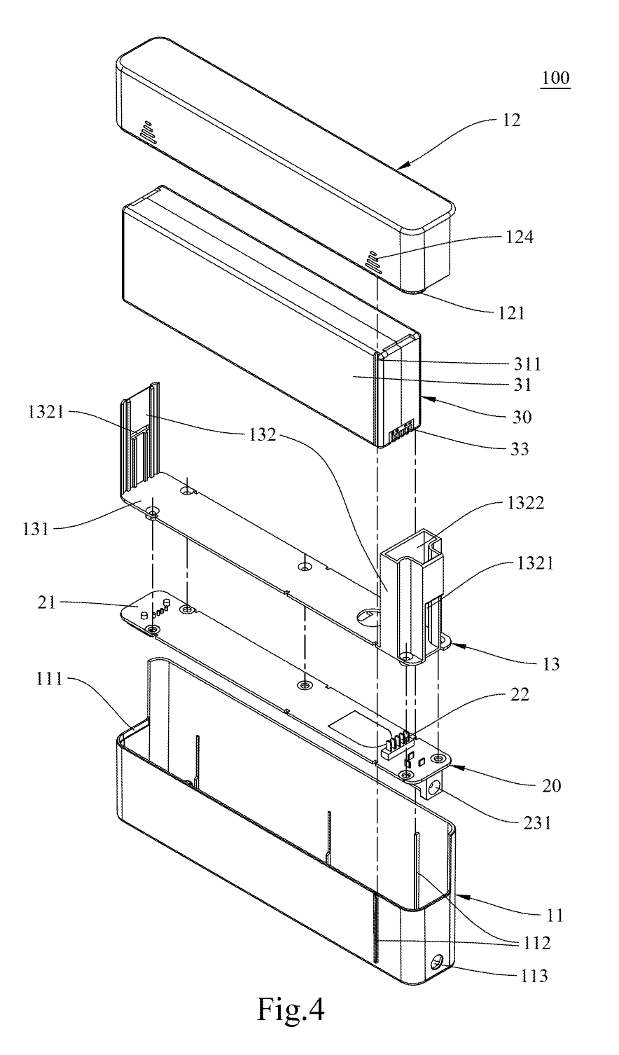

The demountable casing 10 is demounted or mounted by a demountable means. The demountable casing 10 comprises a bottom cover 11 and a top cover 12 for covering the bottom cover 11 by the demountable means. In a preferred embodiment aspect of the present invention, a first step 111 defined by a clearance is disposed at the rim of the opening of the bottom cover 11, whereas a second step 121 is disposed at the rim of the opening of the top cover 12, corresponding in position to and insertedly disposed at the first step 111, so as to cover the bottom cover 11 with the top cover 12. In a preferred embodiment aspect, as shown in FIG. 3 and FIG. 4, the opening of the bottom cover 11 and the opening of the top cover 12 are L-shaped and correspond in position to each other. The demountable means between the bottom cover 11 and the top cover 12 is not restricted to the aforesaid embodiment aspect, as a specific embodiment aspect of the demountable means includes a latch structure, engagement structure, magnetic attraction structure, spring structure, leaf spring structure, pivotal rotation structure, screwing structure, or any other coupling means of demounting and mounting the bottom cover 11 and the top cover 12, but the present invention is not limited thereto.

The demountable casing 10 further comprises a limiting device 13 disposed between the bottom cover 11 and the top cover 12. In a preferred embodiment aspect of the present invention, the limiting device 13 comprises a bottom board 131 and two fixing portions 132 disposed at two ends of the bottom board 131, respectively, to clamp the changeable battery pack 30. The changeable battery pack 30 and the control module 20 are disposed on one side or two sides of the bottom board 131, respectively. In a preferred embodiment aspect of the present invention, the changeable battery pack 30 and the control module 20 are disposed on two sides of the bottom board 131 of the limiting device 13, respectively.

The fixing portions 132 of the limiting device 13 are any components capable of clamping the changeable battery pack 30, such as a latch structure, engagement structure, magnetic attraction structure, spring structure, leaf spring structure, or any other means of mounting the changeable battery pack 30 firmly in place inside the demountable casing 10. In a preferred embodiment aspect of the present invention, an insertion hole 1321 is disposed on one side of each fixing portion 132, whereas a vertical limiting portion 122 insertable into the insertion hole 1321 is disposed on each of the two sides of the top cover 12. As soon as the bottom cover 11 is covered with the top cover 12, the vertical limiting portion 122 engages with the insertion hole 1321 and thus prevents the top cover 12 from moving in the direction of height. A slot 1322 is disposed on one side of each fixing portion 132 to face the top cover 12. A lateral limiting portion 123 insertable into the slot 1322 is disposed on the inner side of the top cover 12. As soon as the bottom cover 11 is covered with the top cover 12, the lateral limiting portion 123 is inserted into the slot 1322 to prevent the top cover 12 from moving horizontally.

At least one pushing structure 124 is disposed on the outer side of the top cover 12. The pushing structure 124 provides friction to users and thus enables the users to push the top cover 12 open by pressing and pushing the pushing structure 124 toward the opposite side of the bottom cover 11. In a preferred embodiment aspect of the present invention, as shown in FIG. 2, the pushing structure 124 is a plurality of strip-shaped structures protrudingly disposed on the top cover 12. The preferred embodiment aspect of the present invention is not restrictive of the number and length of the strip-shaped structures, and thus the strip-shaped structures will work, provided that they enable friction to be generated between a user's hand and the pushing structure 124 such that the user can easily push the top cover 12 open. For instance, the strip-shaped structures are not only in the number of three or more but are also of equal length or decreasing lengths, or alternating between long length and short length. In a preferred embodiment aspect, the pushing structures 124 are disposed on the outer side of the top cover 12 and aligned horizontally to oppose each other. According to the present invention, in addition to the aforesaid protruding strip-shaped structures, the pushing structures 124 are convex structures (such as convex dots and convex rings), concave structures (such as concave rings and concave grooves), or coarse surfaces capable of generating friction. The coarse surfaces either result from having the top cover 12 made of a friction-generating material or covering the top cover 12 with a friction-generating covering layer, but the present invention is not restrictive of any specific embodiment aspect of the pushing structure 124.

The control module 20 is disposed in the demountable casing 10. The control module 20 comprises a circuit controlling board 21, a first electrical connection port 22 electrically connected to the circuit controlling board 21, and at least one socket 23 electrically connected to the circuit controlling board 21. The control module 20 is electrically connected to the changeable battery pack 30 through the first electrical connection port 22. The socket 23 is preferably implemented as a USB socket 231 and a DC socket 232. In a preferred embodiment aspect, as shown in FIG. 3 and FIG. 4, the bottom cover 11 has openings 113, 114 corresponding in position to the USB socket 231 and the DC socket 232 such that the mobile charging device 100 is connected to an external device through the USB socket 231 or the DC socket 232.

The control module 20 further comprises a control interface. In a preferred embodiment aspect of the present invention, the control interface is a physical key 24. In another preferred embodiment aspect of the present invention, the control interface is a virtual touch key or any other operable interface.

The control module 20 further comprises at least one display unit for displaying a remaining power level of the changeable battery pack 30. In a preferred embodiment aspect of the present invention, the at least one display unit is at least one indicating lamp 25. In another preferred embodiment aspect, the display unit is a display screen for displaying information related to the changeable battery pack 30.

By operating the control interface, the users not only begin using the mobile charging device 100 but also set the mobile charging device 100 to a power-saving mode. In the power-saving mode, not only is the mobile charging device 100 precluded from operating in an operating mode (which inevitably necessitates power consumption), but the users can also operate the control interface in order to display power-related information of the mobile charging device 100 while not using the mobile charging device 100. In a preferred embodiment aspect of the present invention, the control interface is a physical key 24 and the bottom cover 11 has an opening 115 corresponding in position to the physical key 24 to facilitate user operation.

After the mobile charging device 100 has started, the display unit has its illumination light on or flashing, depending on the remaining power level of the changeable battery pack 30, so as to inform the users of the remaining power level of the changeable battery pack 30. If the display unit is the indicating lamp 25, the display mode of the indicating lamp 25 allows the indicating lamp 25 to have its illumination light on, flashing, or manifesting variations in light color, but the present invention is not limited thereto. In a preferred embodiment aspect of the present invention, if the display unit is the indicating lamp 25, the bottom cover 11 further has at least one opening 116 corresponding in position to the indicating lamp 25, so as to render it easy for the users to discern the indicating lamp 25. In another preferred embodiment aspect, the bottom cover 11 is light-penetrable in whole or in part to render the illumination light of the indicating lamp 25 visible without the need to drill any hole/opening in the bottom cover 11.

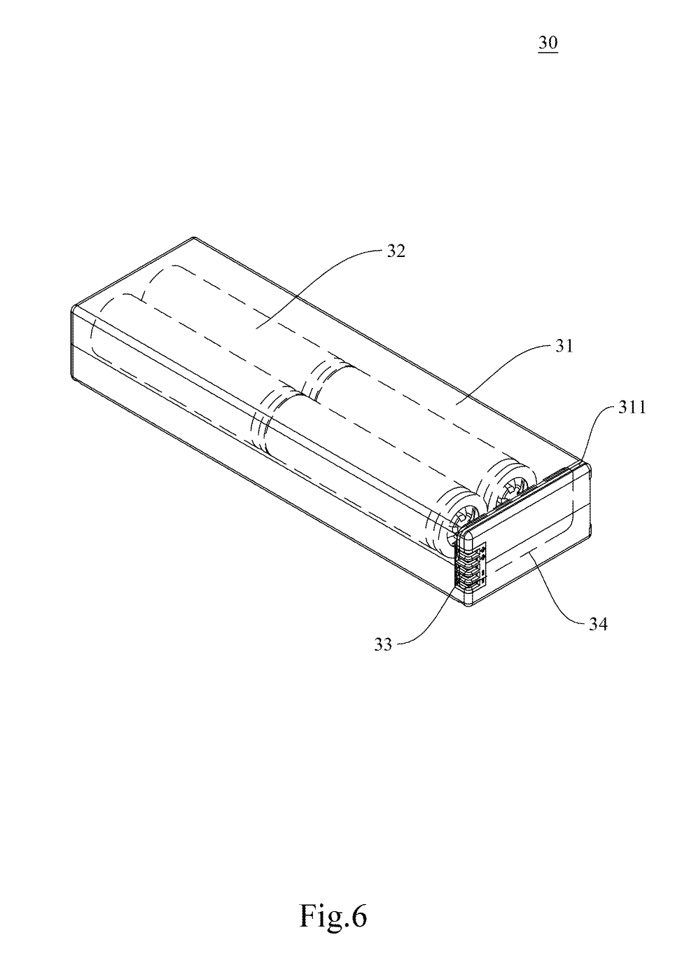

Referring to FIG. 6, there is shown a perspective view of the changeable battery pack of the present invention.

Referring to FIG. 2 through FIG. 4, the changeable battery pack 30 is disposed in the demountable casing 10, electrically connected to the control module 20, controlled by the control module 20 to perform charging or discharging, and is changeable when the demountable casing 10 is demounted.

The changeable battery pack 30 comprises a battery casing 31 or a shrink film (not shown), at least one electric power storage component 32 disposed in the battery casing 31 or the shrink film, and a second electrical connection port 33 electrically connected to the electric power storage component 32. The changeable battery pack 30 is electrically connected to the control module 20 through the second electrical connection port 33. The changeable battery pack 30 further comprises a cell protecting board (not shown) and a circuit board 34 electrically connected to the electric power storage component 32 and the second electrical connection port 33 to preclude any negative factor, such as overly high overvoltage, overly high current, or overly high temperature, which might otherwise cause damage to the electric power storage component 32. The cell protecting board is independent of the circuit board 34 or the cell protecting board and is integrally formed with the circuit board 34, but the present invention is not limited thereto. Preferably, the electric power storage component 32 can be charged and discharged repeatedly and is implemented as lithium-ion batteries or lithium-ion polymer batteries shown in FIG. 6. The present invention is not restrictive of the type, specification and shape of the electric power storage component 32.

At least one first positioning portion is disposed on one side or two sides of the changeable battery pack 30. A second positioning portion is disposed on one side or two sides of inner side of the demountable casing 10, corresponds in position to and is coupled to the first positioning portion such that the changeable battery pack 30 is insertedly positioned at a correct location. In a preferred embodiment aspect of the present invention, the first positioning portion is implemented as guiding grooves 311 disposed on two sides of the battery casing 31, respectively, whereas the second positioning portion is implemented as fool-proof ribs 112, 125 disposed on two inner sides of the top cover 12 and the bottom cover 11, respectively. With the fool-proof ribs 112, 125 being insertedly disposed in the guiding grooves 311, it is impossible for the changeable battery pack 30 to be wrongly mounted in place. The guiding grooves can be swapped for the fool-proof ribs, and vice versa, to still achieve fool-proofing. The present invention is not restrictive of the embodiment aspect of the first positioning portion and the second positioning portion.

Various ways of using the mobile charging device 100 of the present invention are described below.

If the display unit of the mobile charging device 100 displays that it has insufficient power or has run out of power, the users may remove the old changeable battery pack 30 from the mobile charging device 100 and then place the new changeable battery pack 30 therein in order to continue using the mobile charging device 100. The mobile charging device 100 is electrically connected to the DC socket 231 and an external power source equipment by a power supply line. The control module 20 controls the changeable battery pack 30 to receive and store power transmitted from the external power source equipment and restores the power level of the changeable battery pack 30 by charging the changeable battery pack 30.

According to the present invention, both the DC socket 231 and the USB socket 232 can be discharged by electrically connecting one end of a power transmission line to the DC socket 231 or USB socket 232 and electrically connecting the other end of the power transmission line to the electronic device. The control module 20 controls the changeable battery pack 30 to transmit electric power to the electronic device to be charged.

In summary, the mobile charging device of the present invention has a demountable casing. The demountable casing has therein demountable and changeable batteries. If the mobile charging device runs out of power or the batteries lose their electric power storage capability, the batteries will be changed, so as to ensure their charging function and enhance practicability and convenience of the mobile charging device.

The above is the detailed description of the present invention. However, the above is merely the preferred embodiment of the present invention and cannot be the limitation to the implement scope of the present invention, which means the variation and modification according the present invention may still fall into the scope of the invention.

What is claimed is:

1. A mobile charging device capable of battery replacement, comprising:
a demountable casing demounted or mounted by a demountable means;
a control module disposed in the demountable casing; and
a replaceable battery pack disposed in the demountable casing, electrically connected to the control module, controlled by the control module to perform charging or discharging, and is changeable when the demountable casing is demounted.

2. The mobile charging device of claim 1, wherein the demountable casing comprises a bottom cover and a top cover for covering the bottom cover by the demountable means; and, the demountable means includes a latch structure, engagement structure, magnetic attraction structure, spring structure, leaf spring structure, pivotal rotation structure, or screwing structure.

3. The mobile charging device of claim 2, wherein at least one pushing structure is disposed on the outer side of the top cover.

4. The mobile charging device of claim 3, wherein the pushing structure is convex structure, concave structure, or coarse surface capable of generating friction.

5. The mobile charging device of claim 2, wherein the demountable casing further comprises a limiting device disposed between the bottom cover and the top cover.

6. The mobile charging device of claim 1, wherein the control module comprises a circuit controlling board, a first electrical connection port electrically connected to the circuit controlling board, and at least one socket electrically connected to the circuit controlling board; and, the control module is electrically connected to the changeable battery pack through the first electrical connection port.

7. The mobile charging device of claim 6, wherein the socket is a USB socket and/or a DC socket.

8. The mobile charging device of claim 1, wherein the changeable battery pack comprises a battery casing or a shrink film, at least one electric power storage component disposed in the battery casing or the shrink film, and a second electrical connection port electrically connected to the electric power storage component; and, the changeable battery pack is electrically connected to the control module through the second electrical connection port.

9. The mobile charging device of claim 8, wherein the changeable battery pack further comprises a cell protecting board and a circuit board electrically connected to the electric power storage component and the second electrical connection port; and, the cell protecting board is independent of the circuit board or integrally formed with the circuit board.

10. The mobile charging device of claim 8, wherein at least one first positioning portion is disposed on one side or two sides of the changeable battery pack; and, a second positioning portion is disposed on one side or two sides of inner side of the demountable casing, corresponds in position to and is coupled to the first positioning portion.

11. The mobile charging device of claim 1, wherein the control module further comprises a control interface.

12. The mobile charging device of claim 1, wherein the control module further comprises a display unit for displaying a remaining power level of the changeable battery pack.

13. The mobile charging device of claim 12, wherein the display unit is at least one indicating lamp or a display screen.

14. The mobile charging device of claim 1, wherein the mobile charging device is applicable to fields of nail industry.
